(19) United States
(12) Patent Application Publication
(10) Pub. No.: US 2016/0087336 A1
(43) Pub. Date: Mar. 24, 2016

(54) SYSTEMS AND METHODS FOR OPTIMIZING WIRELESS COMMUNICATION

(71) Applicants: ALEXANDER MALTSEV, Nizhny Novgorod (RU); VADIM SERGEYEV, Nizhny Novgorod (RU); GREGORY V. MOROZOV, Nizhny Novgorod (RU); ALEXEI DAVYDOV, Nizhny Novgorod (RU)

(72) Inventors: ALEXANDER MALTSEV, Nizhny Novgorod (RU); VADIM SERGEYEV, Nizhny Novgorod (RU); GREGORY V. MOROZOV, Nizhny Novgorod (RU); ALEXEI DAVYDOV, Nizhny Novgorod (RU)

(21) Appl. No.: 14/495,175

(22) Filed: Sep. 24, 2014

(51) Int. Cl. H01Q 3/00

(52) U.S. Cl. CPC H01Q 3/00

(57) ABSTRACT

Systems and methods for optimizing wireless communication are provided. An example method may include selecting a first direction at which to direct a first directional antenna beam, and selecting a second direction at which to direct a second directional antenna beam. The method may also include transmitting a first signal in the first direction, and transmitting a second signal in the second direction. The method may include receiving a first response to the first signal from a first user device, and receiving a second response to the second signal from a second user device. The method may include determining a first beam setting for the first user device based at least in part on the first response, and determining a second beam setting for the second user device based at least in part on the second response.

### TECHNICAL FIELD

This disclosure generally relates to wireless communication, and more particularly to systems and methods for optimizing wireless communication.

### BACKGROUND

Effective wireless communication between two or more devices may be dependent on signals or antenna beams transmitted or received by each device. Steering or targeting signals or antenna beams transmitted from either device towards the other may improve or increase quality of wireless connections and communication. Other factors that affect wireless communication between devices may include antenna beam size and signal strength. Narrow antenna beams may result in targeting difficulties for either or both devices, leading to frequent updating of beam settings provided by either device. Frequent updating of beam settings may be a time consuming process. Accordingly, systems and methods for optimizing wireless communication may be desired.

### BRIEF DESCRIPTION OF THE FIGURES

Reference will now be made to the accompanying drawings, which are not necessarily drawn to scale, and wherein:

FIG. 1 is an illustrative example environment of a wireless communication system, in accordance with example embodiments of the disclosure.

FIG. 2 is an illustrative schematic diagram of an example wireless communication system, in accordance with example embodiments of the disclosure.

FIG. 3 is a flow diagram illustrating an example method for optimizing wireless communication, in accordance with certain example embodiments of the disclosure.

FIGS. 4-6 are illustrative schematic diagrams of an access point implementing the method of FIG. 3, in accordance with example embodiments of the disclosure.

FIG. 7 is a flow diagram illustrating another example method for optimizing wireless communication, in accordance with certain example embodiments of the disclosure.

FIGS. 8-11 are illustrative schematic diagrams of an access point implementing an alternative embodiment of the method of FIG. 7, in accordance with example embodiments of the disclosure.

FIGS. 12-13 are exemplary graphs depicting transmissions and responses of a wireless communication system measured over time, in accordance with certain example embodiments of the disclosure.

### DETAILED DESCRIPTION OF EMBODIMENTS OF THE DISCLOSURE

Embodiments of the disclosure are described more fully hereinafter with reference to the accompanying drawings, in which example embodiments of the disclosure are shown. This disclosure may, however, be embodied in many different forms and should not be construed as limited to the example embodiments set forth herein; rather, these embodiments are provided so that this disclosure will be thorough and complete, and will fully convey the scope of the invention to those skilled in the art. Like numbers refer to like, but not necessarily the same or identical, elements throughout.

Example embodiments of the disclosure may provide systems and methods for optimizing wireless communication for one or more devices, which include, but are not limited to, access points, mobile communication devices including laptops, smartphones, tablets, wearables (including headsets, watches, health monitors, etc.), or other wireless devices or apparatuses. Example embodiments may include one or more user devices within range of and/or wirelessly connected to a wireless apparatus, such as an access point. Although examples of the present disclosure are directed to access points, any wireless apparatus may be used and is contemplated within the present disclosure. In this example embodiment, the access point, and in some instances the user device, may include a directional antenna array and may be configured to direct antenna beams in different directions. The antenna beams directed by the access point may be signals with directionality configured to search for or discover user devices and/or to transmit or receive data to and/or from connected user devices. For example, the antenna beams of the access point may include a probe beacon that may be received by an unconnected user device positioned in the direction and/or within the range of the antenna beam. The user device may receive the probe beacon and may transmit a response to the access point. In another example, the antenna beams may transmit and/or receive data to and from connected user devices to update beam settings for connected user devices, as described herein. Beam settings, as described herein, may provide information related to preferred or optimal signal settings or selections of the user device or access point. For example, beam settings may include a preferred antenna direction selection, or in some instances, a preferred antenna sector or subsector selection of the user device, as discussed below.

In example embodiments, the access point or wireless apparatus may be configured to direct continuously steerable antenna beams in different directions. In embodiments with continuously steerable antenna beams, antenna beams may be steered in any direction within a coverage area or coverage angle of an access point. In order to maintain or optimize wireless communication with connected user devices or to search for unconnected user devices within range of the access point, the access point may perform a searching operation, which may include searching at least two antenna beams in two different directions at substantially the same time, or substantially in parallel. One example of a searching operation as described herein includes transmitting a probe beacon, by the access point, via a first antenna beam in a first antenna beam direction and via a second antenna beam in a second antenna beam direction at substantially the same time. The first antenna beam may be spaced from the second antenna beam so as to reduce interference or error. The access point may then search other beam directions in parallel, until all beam directions are searched.

In some embodiments, the wireless apparatus may select a first direction at which to direct a first directional antenna beam, the first direction selected from a first set of antenna beam directions comprising a first plurality of antenna beam directions. The wireless apparatus may select a second direction at which to direct a second directional antenna beam, the second direction selected from a second set of antenna beam directions comprising a second plurality of antenna beam directions. The wireless apparatus may transmit a first signal in the first direction, and may transmit a second signal in the second direction. The wireless apparatus may receive a first response to the first signal from a first user device, and may receive a second response to the second signal from a second user device. The wireless apparatus may determine a first beam setting for the first user device based at least in part on the first response, and may determine a second beam setting for the second user device based at least in part on the second response.

In other embodiments, the access point may perform the searching operation in a sector sweep, where the access point defines sectors within a coverage area and identifies subsectors within the sectors. The access point may search each first subsector of each antenna sector at substantially the same time, followed by each second subsector of each antenna sector, and so forth in succession until each subsector of each antenna sector is searched. In some embodiments, for example where the access point is highly flexible or has sufficient processing and hardware capabilities, all subsectors may be searched at substantially the same time. By searching multiple beam directions or subsectors at substantially the same time, the total length of time for detection of unconnected user devices and for optimizing and updating beam settings for wireless communication quality with connected devices may be reduced.

Embodiments of the disclosure may include an access point with a directional antenna array and one or more user devices that may also include directional antenna arrays. The respective directional antenna arrays may include multiple antenna elements, where each antenna element is configured to emit a signal of varying phase and/or magnitude in accordance with a distribution, resulting in directional signal emission by the antenna elements. The access point and user devices may be configured for directional transmission, where transmitted signals are stronger in a particular direction than in other directions due to increased power supplied to corresponding antenna array elements (e.g., due to distribution of specific magnitudes and/or phases of the signals supplied to corresponding antenna elements).

In example embodiments, the user devices discussed herein may have one or more antennas and/or transceivers for communicating with one another and/or the access point. The access point and the user devices may be configured to transmit or receive beacons or other data packets or frames from each other. Sample forms of wireless communication may include millimeter wave band, WiGig, WiFi, WiFi Direct, BLUETOOTH™, BLUETOOTH LE™, Near Field Communication, 3G/4G /5G or other cellular communication, and other forms of wireless communication. In example embodiments, the user devices may be configured to facilitate searching operations performed by the access point.

It will be appreciated that in example embodiments, the systems and methods described herein may provide for and result in increased efficiency in optimizing wireless connections and/or detecting unconnected user devices by searching subsectors of antenna sectors substantially in parallel, or at the same time.

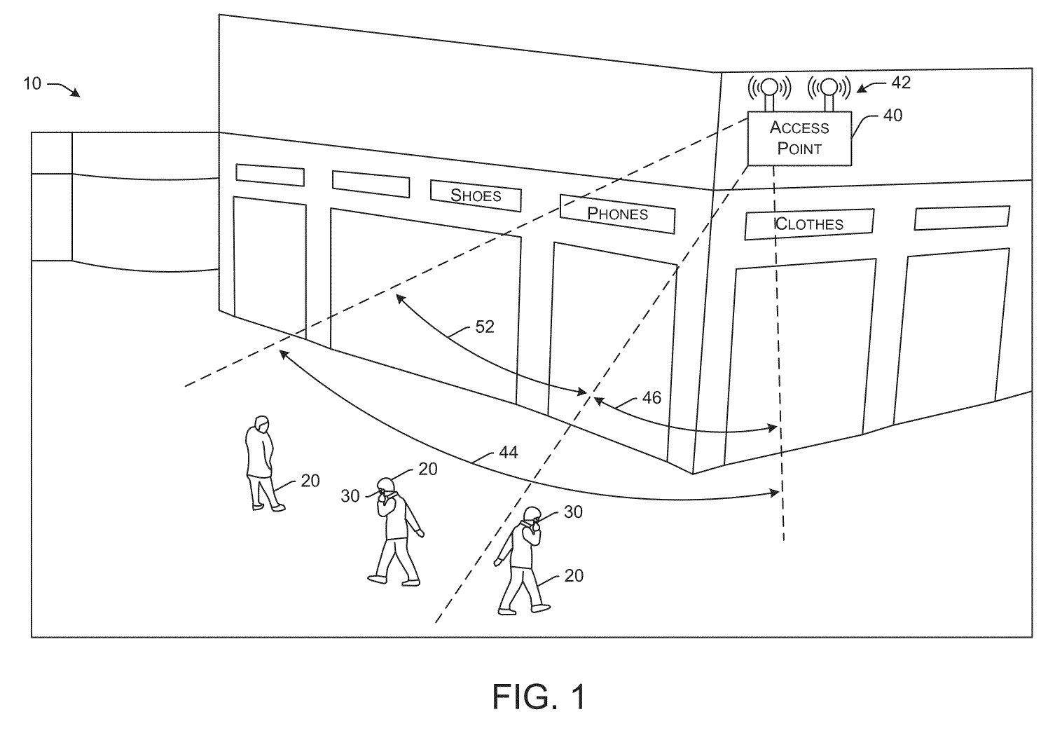

Some example elements involved in the operation of the systems, methods, and apparatus disclosed herein may be better understood with reference to the figures. Referring generally to FIG. 1, an illustrative environment of the disclosure is provided. In FIG. 1, an indoor or outdoor mall 10 may have several consumers or users 20 in, for example, common areas of the mall 10. The users 20 may have user devices 30, for example smartphones, tablets, laptop computers, or other mobile devices. Some of the user devices 30 may be wirelessly connected to an access point 40 with a directional antenna array 42 positioned within the mall 10. Other user devices 30 may desire to connect to the access point 40. The access point 40 may be configured to direct antenna beams, or signals with specific directionality, about its coverage area 44, using the directional antenna array 42, for example. In some embodiments, the access point 40 may define sets of antenna beam directions about the access point 40 within its coverage area 44, where each set of antenna beam directions includes pluralities of antenna beam directions. The access point 40 may further identify at least two sets of antenna beam directions. For example, the access point 40 may define a first set of antenna beam directions 46 and a second set of antenna beam directions 52. The antenna beams directed by the access point 40 may allow for wireless data transmission between the user devices 30 positioned within the coverage area 44 and the access point 40.

As the users 20 walk or otherwise move about the mall 10, the respective user devices 30 may move along with the users 20, and may therefore move to different positions with respect to the access point 40. For example, a user device may move from a position within the first set of antenna beam directions 46 to a position within the second set of antenna beam directions 52. In embodiments without defined sets of antenna beam directions, user devices may move from a position near a first antenna beam to a position near a second antenna beam, as discussed below. In order to improve or optimize the wireless connection for data transmission between each of the connected user devices 30 and the access point 40 as the user devices 30 move about the access point 40, or to discover unconnected user devices, the access point 40 may periodically perform a searching operation. The searching operation may allow the access point 40 to determine which antenna beam direction each specific user device 30 is positioned within or nearest to. The antenna beam direction within which each specific user device 30 is positioned may correspond to the physical location of each user device 30 with respect to the access point 40. The searching operation may also allow the access point 40 to detect or discover unconnected user devices that desire to connect to the access point 40, as described herein. The searching operation may include transmitting a signal, for example, to request information from user devices within a specific antenna sector and/or subsector, as described herein.

Since the access point 40 may not receive updates on antenna beam direction positioning from connected user devices 30, the access point 40 may periodically perform the searching operation to update beam settings of each connected user device 30. The access point 40 may direct a relatively stronger signal or antenna beam with more power to each connected user device 30 based at least in part on the response received to the signal transmitted by the access point 40. The access point 40 may thereby improve the quality of the wireless connection between the access point 40 and each user device 30. The searching operation may be performed by the access point 40 periodically and may include searching more than one antenna beam direction at substantially the same time. For example, the access point 40 may transmit a signal in a first direction selected from the first set of antenna beam directions 46, and may transmit another signal in a second direction selected from the second set of antenna beam directions 52 at substantially the same time. In some embodiments, the access point 40 may wait a length of time for a response from any user devices between successive signals, that is, before searching antenna beam directions, while in other embodiments the access point 40 may not wait for responses from the user devices 30 before additional antenna beam directions, as discussed herein. In some embodiments, signals may be emitted by the access point 40 at a set delay or predetermined time interval or may be responsive to a communication received from the user devices 30. The length of time spent searching by the access point 40 may therefore be reduced when compared to instances where the access point 40 sequentially searches each antenna sector or subsector. In the present disclosure, the access point 40 may be configured to search multiple antenna beam directions in parallel or at substantially the same time.

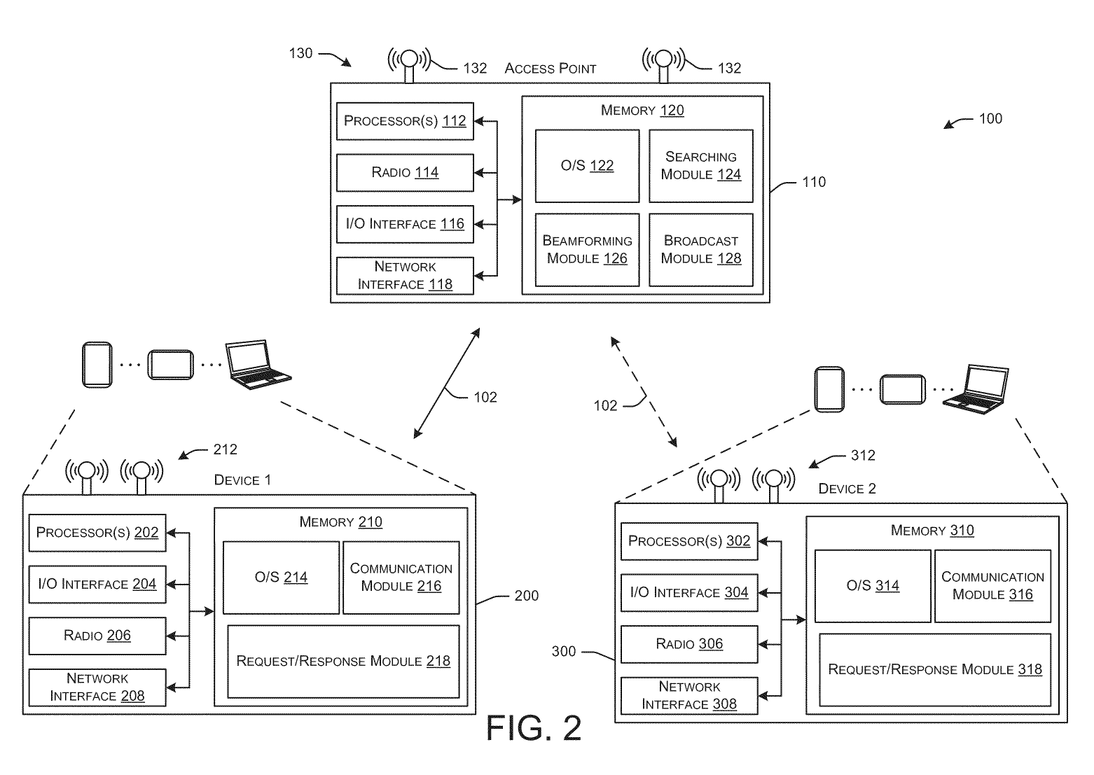

Referring now to FIG. 2, a simplified schematic diagram illustrating an example wireless communication system 100 in accordance with embodiments of the disclosure is depicted. In the illustrated embodiment, the wireless communication system 100 includes a wireless apparatus, such as an access point 110, a first user device 200, and a second user device 300. The access point 110 may be analogous to the access point 40, and the user devices 200, 300 may be analogous to the user devices 30 of FIG. 1. The first user device 200 may have an established wireless connection 102 with the access point 110, and the second user device 300 may not be connected to the access point 110.

The access point 110 may include one or more processor(s) 112, a radio 114, an input/output interface (I/O) 116, and a network interface 118. The access point 110 includes a directional antenna array 130 that may be communicatively coupled to the radio 114. The directional antenna array 130 may include multiple antenna elements 132 configured to direct antenna beams, or signals with specific directionality. Each component 112, 114, 116, 118 may be communicatively coupled to a memory 120. The memory 120 of the access point 110 may store program instructions that are loadable and executable on the processor 112, as well as data generated or received during the execution of these programs. Turning to the contents of the memory 120 in more detail, the memory 120 may include several modules. Each of the modules and/or software may provide functionality for the access point 110, when executed by the processor 112. The modules and/or the software may or may not correspond to physical locations and/or addresses in the memory 120. In other words, the contents of each of the modules may not be segregated from each other and may, in fact be stored in at least partially interleaved positions on the memory 120.

The memory 120 may include an operating system (O/S) 122, a searching module 124, a beamforming module 126, and a broadcast module 128. The processor 112 may be configured to access and execute the operating system 122 stored in the memory 120 to operate the system functions of the access point 110. System functions, as managed by the operating system 122 may include memory management, processor resource management, driver management, application software management, system configuration, and the like. The operating system 122 may be any variety of suitable operating systems including, but not limited to, Google® Android®, Microsoft® Windows®, Microsoft® Windows® Server®, Linux, Apple® OS-X®, or the like. The operating system 122 may provide users with a guided user interface and/or may provide software logic used to control the wireless communication system 100.

The searching module 124 of the access point 110 may include instructions and/or applications that may be executed by the processor 112 to provide one or more functionality associated with the directional transmission and reception of wireless signals and task processing, for example during searching operations. These instructions and/or applications may, in certain aspects, interact with the operating system 122 and/or other modules. The beamforming module 126 may include instructions and/or applications thereon that may be executed by the processor 112 to provide one or more functionality associated with management of a directional antenna array associated with the access point 110. The broadcast module 128 may include instructions and/or applications that may be executed by the processor 112 to provide one or more functionality associated with transmission, reception, or emission of beacons, for example probe beacons. Although each of these components is shown in the illustrated embodiment, other embodiments may include additional or fewer components.

The first and second user devices 200, 300 may be any device configured to execute one or more applications, software, and/or instructions to provide one or more services to a user. The user devices 200, 300, as used herein, may be any variety of client devices, electronic devices, communications devices, and/or other user devices. The first and second user devices 200, 300 may include, but are not limited to, tablet computing devices, electronic book (ebook) readers, netbook computers, Ultrabook™, notebook computers, laptop computers, desktop computers, watches or other wearables, health monitors, personal digital assistants (PDAs), smart phones, web-enabled televisions, video game consoles, set top boxes (STB), or the like. While the drawings and/or specification may portray the user devices 200, 300 in the likeness of a smartphone, a tablet, or a laptop computer, the disclosure is not limited to such. Indeed, the systems and methods described herein may apply to any mobile device or user device capable of communicating with the access point 110 of the wireless communication system 100. The user devices may be used by users for a variety of purposes, including, but not limited to, functionality such as web browsing, business funtions, communications, graphics, word processing, publishing, spreadsheets, databases, gaming, education, entertainment, media, project planning, engineering, drawing, or combinations thereof.

In the illustrated embodiment, the first user device 200 includes one or more processor(s) 202, an input/output interface (I/O) 204, a radio 206, and a network interface 208. Each component 202, 204, 206, 208 may be communicatively coupled to a memory 210. The memory 210 may be configured as described above. The first user device 200 further includes an antenna 212, which may be a directional antenna array, in communication with radio 206. The memory 210 includes an operating system (O/S) 214, a communication module 216, and a request/response module 218. The operating system 214 may provide users with a guided user interface and/or may provide software logic used to control the first user device 200. System functions, as managed by the operating system 214 may include memory management, processor resource management, driver management, application software management, system configuration, and the like. The operating system 214 may be any variety of suitable operating systems including, but not limited to, Google® Android®, Microsoft® Windows®, Microsoft® Windows® Server®, Linux, Apple® OS-X®, or the like. The communication module 216 may be configured to coordinate transmission and/or reception of electronic communications. The request/response module 218 may be a mobile application stored on the memory 210 and may be configured to retrieve or determine beam setting preferences, such as preferred antenna sector and/or subsector settings, determined by the first user device 200. The request/response module 218 may be configured to determine responses to probe beacons received by the first user device 200, for example from the access point 110. The request/response module 218 may be configured to direct transmission of requests for a probe beacon, for example from the access point 110. Although each of these components is shown in the illustrated embodiment, other embodiments may include additional or fewer components.

Similarly, the second user device 300 includes one or more processor(s) 302, an input/output interface (I/O) 304, a radio 306, and a network interface 308. Each component 302, 304, 306, 308 may be communicatively coupled to a memory 310. The memory 310 may be configured as described above. The second user device 300 further includes an antenna 312, which may be a directional antenna array, in communication with the radio 306. The memory 310 includes an operating system (O/S) 314, a communication module 316, and a request/response module 318. The operating system 314 may provide users with a guided user interface and/or may provide software logic used to control the second user device 300. System functions, as managed by the operating system 314 may include memory management, processor resource management, driver management, application software management, system configuration, and the like. The operating system 314 may be any variety of suitable operating systems including, but not limited to, Google® Android®, Microsoft® Windows®, Microsoft® Windows® Server®, Linux, Apple® OS-X®, or the like. The communication module 316, as discussed above, may be configured to coordinate transmission and/or reception of electronic communications. The request/response module 318 may be a mobile application stored on memory 310 and may be configured to retrieve or determine beam setting preferences, such as preferred antenna sector and/or subsector settings, determined by the second user device 300. The request/response module 318 may be configured to determine responses to probe beacons received by the second user device 300, for example from the access point 110. The request/response module 318 may be configured to direct transmission of requests for a probe beacon, for example from access point 110. Although each of these components is shown in the illustrated embodiment, other embodiments may include additional or fewer components.

Each respective processor 112, 202, 302 of the access point 110 and the user devices 200, 300 may be implemented as appropriate in hardware, software, firmware, or combinations thereof. Software or firmware implementations of the processors 112, 202, 302 may include computer-executable or machine-executable instructions written in any suitable programming language to perform the various functions described. Hardware implementations of the processors 112, 202, 302 may be configured to execute computer-executable or machine-executable instructions to perform the various functions described. The processors 112, 202, 302 may include, without limitation, a central processing unit (CPU), a digital signal processor (DSP), a reduced instruction set computer (RISC), a complex instruction set computer (CISC), a microprocessor, a microcontroller, a field programmable gate array (FPGA), or any combination thereof. The access point 110 and/or user devices 200, 300 may also include a chipset (not shown) for controlling communications between one or more processors 112, 202, 302 and one or more of the other components of the access point 110 or user devices 200, 300. The processors 112, 202, 302 may also include one or more application specific integrated circuits (ASICs) or application specific standard products (ASSPs) for handling specific data processing functions or tasks. In certain example embodiments, the access point 110 and/or user devices 200, 300 may be based on an Intel® Architecture system and the processors 112, 202, 302 and chipset may be from a family of Intel® processors and chipsets, such as the Intel® Atom® processor family.

The input/output interfaces 116, 204, 304 included in the access point 110 and user devices 200, 300 may enable the use of one or more user interfaces for receiving user input and/or providing output to the user. A user may be able to administer or manage the systems and methods disclosed herein by interacting with the access point 110 or user devices 200, 300 via the input/output interfaces 116, 204, 304, such as a touchscreen interface, a display, a guided user interface, or any other input/output interface. The input/output interfaces 116, 204, 304 may be in the form of a touch screen, a microphone, an accelerometer sensor, a speaker, or any other suitable input/output interfaces 116, 204, 304 that may be used by the user to interact with the access point 110 or user devices 200, 300.

The memory 120 of the access point 110, as well as the memory 210, 310 of the first user device 200 and second user device 300, respectively, may include one or more volatile and/or non-volatile memory devices including, but not limited to, magnetic storage devices, read only memory (ROM), random access memory (RAM), dynamic RAM (DRAM), static RAM (SRAM), synchronous dynamic RAM (SDRAM), double data rate (DDR) SDRAM (DDR-SDRAM), RAM-BUS DRAM (RDRAM), flash memory devices, electrically erasable programmable read only memory (EEPROM), non-volatile RAM (NVRAM), universal serial bus (USB) removable memory, or combinations thereof.

The radios 114, 206, 306 of the access point 110 and/or user devices 200, 300 may be a transmit/receive component, such as a transceiver. The radios 114, 206, 306 may include any suitable radio(s) and/or transceiver(s) for transmitting and/or receiving radio frequency (RF) signals in the bandwidth and/or channels corresponding to the communications protocols utilized by the user devices 200, 300 to communicate with each other or with other user devices and/or the access point 110. The radios 114, 206, 306 may include hardware and/or software to modulate communications signals according to pre-established distribution protocols. The radios 114, 206, 306 may further have hardware and/or software instructions to communicate via one or more Wi-Fi and/or Wi-Fi direct protocols, as standardized by the Institute of Electrical and Electronics Engineers (IEEE) 802.11 standards. In certain embodiments, the radios 114, 206, 306, in cooperation with their respective antennas 130, 212, 312 may be configured to communicate via millimeter wave band communication. Other examples include 2.4 GHz channels (e.g. 802.11b, 802.11g, 802.11n), 5 GHz channels (e.g. 802.11n, 802.11ac), or 60 GHZ channels (e.g. 802.11ad). In alternative embodiments, non-Wi-Fi protocols may be used for communications between the access point 110 and/or user devices 200, 300, such as BLUETOOTH™, BLUETOOTH(™) LE, Near Field Communication, dedicated short-range communication (DSRC), or other packetized radio communications. The radios 114, 206, 306 may include any known receiver and baseband suitable for communicating via the communications protocols of the access point 110 and/or user devices 200, 300. The radios 114, 206, 306 may further include a low noise amplifier (LNA), additional signal amplifiers, an analog-to-digital (A/D) converter, one or more buffers, and digital baseband.

Any or all of the access point 110 and user devices 200, 300 may have multiple antenna elements for directional communication. Such directionality may be achieved by combining the multiple antenna elements into a phased array antenna system, in which each antenna is substantially omnidirectional by itself, but directionality may be achieved by processing the separate signals to or from each antenna in a manner that achieves directionality for the overall antenna array. Directivity of antenna beams may be expressed as an angle between directions in which the angular power density of the radio energy of the beam is lower than maximum value by certain amount of decibels (dB), such as 3 dB. In other embodiments, directivity of antenna beams may be expressed as a width of an antenna sector, for example. The antennas 130, 212, 312 included in the access point 110 and respective user devices 200, 300 may be configured for receiving and/or transmitting communications signals from/to each other or other components of the wireless communication system 100. The antennas 130, 212, 312 may be any suitable type of antenna corresponding to the communications protocols used by the access point 110 and/or user devices 200, 300 for the particular signals received and/or transmitted via the antennas 130, 212, 312. Some non-limiting examples of suitable antennas 130, 212, 312 include directional antennas, non-directional antennas, dipole antennas, folded dipole antennas, patch antennas, multiple-input multiple-output (MIMO) antennas, or the like. Each antenna 130, 212, 312 may be communicatively coupled to a radio component to transmit and/or receive signals, such as communications signals to and/or from the access point 110 and/or the user devices 200, 300.

The antennas 130, 212, 312 may be configured to receive and/or transmit signals in accordance with established standards and protocols, such as Institute of Electrical and Electronics Engineers (IEEE) 802.11 family of standards, including via 2.4 GHz channels (e.g. 802.11b, 802.11g, 802.11n), 5 GHz channels (e.g. 802.11n, 802.11ac), or 60 GHZ channels (e.g. 802.11ad). In alternative example embodiments, the antennas 130, 212, 312 may be configured to receive and/or transmit millimeter wave band, non-Wi-Fi protocol signals, such as BLUETOOTH™, BLUETOOTH™ LE, Near Field Communication, dedicated short-range communication (DSRC), or other packetized radio communications.

The antennas 130, 212, 312 may comprise almost any type of antenna or antenna structure that may provide either a directional or a highly-directional antenna pattern. In some embodiments, one or more horn antennas, reflector antennas, patch antennas, dipole antennas, loop antennas, and/or microstrip antennas may be used. In some embodiments, phase-array antennas may be used. In some embodiments, instead of two or more antennas, a single antenna with multiple apertures may be used. In these embodiments, each aperture may be considered a separate antenna element. In some embodiments that use phased-array antennas, an amplifier element may be provided for each antenna element or for groups of antenna elements, although the scope of the disclosure is not limited in this respect. In some embodiments, a reflector or millimeter-wave lens may be employed by one or more of the antennas to achieve a relatively large vertical aperture size to provide a substantially non-diverging beam in the vertical plane and a diverging beam in the horizontal plane.

In some embodiments, the antennas 130, 212, 312 may comprise a chip-lens array antenna having a millimeter-wave lens to shape the main beam and a chip-array to generate and direct an incident beam of millimeter-wave signals through the millimeter-wave lens for subsequent transmission to the user devices. In some of these embodiments that use a fan-shaped beam, the millimeter-wave lens may have an inner surface and an outer surface with curvatures selected to provide main beam as diverging in the horizontal plane and main beam as substantially non-diverging beam in the vertical plane, although the scope of the disclosure is not limited in this respect.

In some embodiments, the access point 110 may communicate using multicarrier communication signals such as orthogonal frequency division multiplex (OFDM) communication signals. The multicarrier communication signals may be within the millimeter-wave frequency spectrum and may comprise a plurality of orthogonal subcarriers. In some embodiments, the multicarrier signals may be defined by closely spaced OFDM subcarriers. Each subcarrier may have a null at substantially a center frequency of the other subcarriers, and/or each subcarrier may have an integer number of cycles within a symbol period, in some embodiments. In other embodiments, the access point may communicate in accordance with a multiple access technique, such as orthogonal frequency division multiple access (OFDMA). Other forms of communication that may be used by the access point include single-carrier signals and spread-spectrum signals.

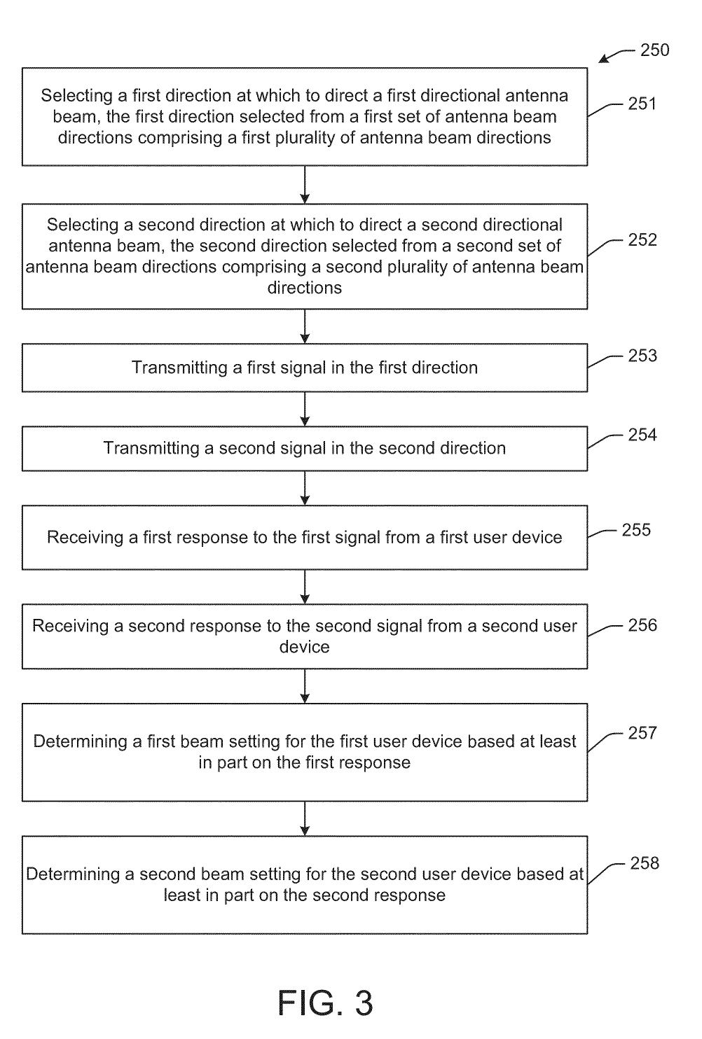

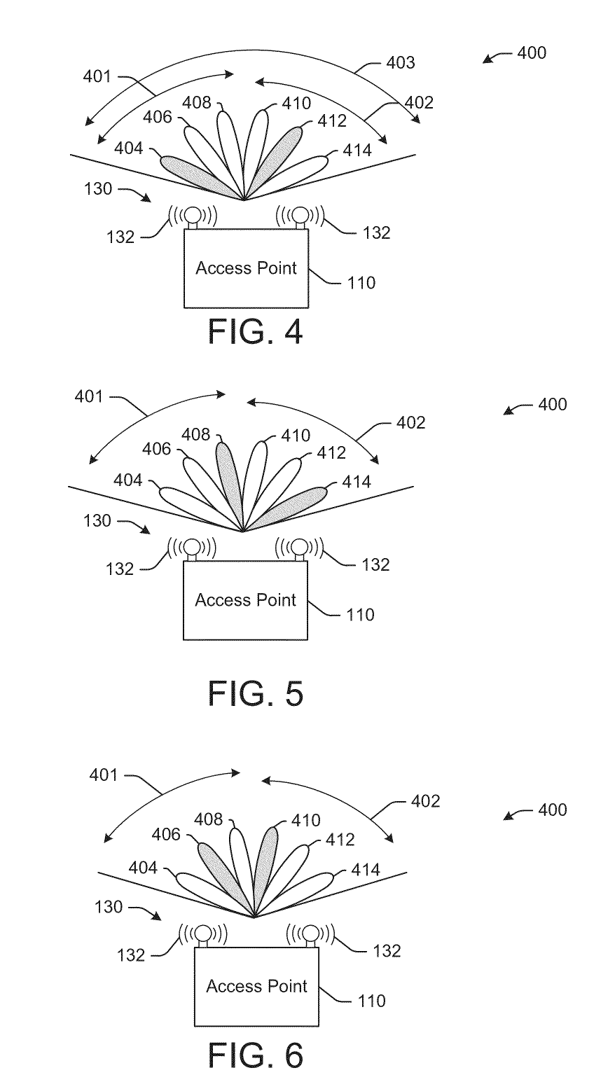

Referring now to FIGS. 3 and 4, an example method 250 of optimizing wireless communication and an example directional transmission 400 from a wireless apparatus, for example the access point 110 of FIG. 2, according to one embodiment of the disclosure are illustrated and will be discussed in conjunction with each other. Referring first to FIG. 3, block 251 of method 250 includes selecting, by a wireless apparatus comprising one or more processors (e.g., access point 110), a first direction at which to direct a first directional antenna beam, the first direction selected from a first set of antenna beam directions comprising a first plurality of antenna beam directions. Block 252 includes selecting, by the wireless apparatus, a second direction at which to direct a second directional antenna beam, the second direction selected from a second set of antenna beam directions comprising a second plurality of antenna beam directions. The first direction and the second direction may be selected such that the first signal received by the first user device positioned in the first direction is a predefined amount of decibels stronger than the second signal received by the first user device. For example, first device 200 of FIG. 2 may observe the first signal, transmitted by the access point 110 of FIG. 2 in the first direction, a predefined amount of decibels stronger than the second signal, transmitted by the access point 110 in the second direction.

In FIG. 4, directional transmission 400 from the access point 110 is illustrated in a top view. The access point 110 may be configured to direct a plurality of antenna beams in different directions across a coverage area 403 of the access point 110. As illustrated in FIG. 4, the access point 110 may direct antenna beams in a first set of antenna beam directions 401 and in a second set of antenna beam directions 402. The first set of antenna beam directions 401 may include a plurality of antenna beam directions, and specifically, a first antenna beam direction 404, a second antenna beam direction 406, a third antenna beam direction 408. The second set of antenna beam directions 402 may include a fourth antenna beam direction 410, a fifth antenna beam direction 412, and a sixth antenna beam direction 414. Each antenna beam direction 404-414 may be different than the others. Although six antenna beams are illustrated, any number of antenna beams may be directed by the access point 110. The access point 110 may direct the antenna beams using antenna elements 132 of the directional antenna array 130 as discussed above. The coverage area 403 may be determined, for example, by the beamforming module 126 of the access point 110. The coverage area 403 may be adjusted by adjusting power and/or phases provided to the antenna elements 132 of the directional antenna array 130 of the access point 110. For example, increasing power to certain antenna elements 132 of the directional antenna array 130 of the access point 110 may result in increased gain and signal strength transmitted from the antenna element 132. The antenna beams may be millimeter wave wireless transmissions sent by the access point 110 in some embodiments. The access point 110 may select a first direction, such as the first antenna beam direction 404, and a second direction, such as the fifth antenna beam direction 412.

Each of the antenna beams directed by the access point 110 may have a beam direction and a narrow beam width, which may allow the antenna beam to be highly focused and allow more precise targeting of radio signals. Use of narrow width antenna beams may assist in decoupling between data streams transmitted over individual antenna beams, which may enable simultaneous data transmission or reception from multiple user devices. Signal processing techniques, such as beamforming or spatial filtering may be used by the access point 110 for directional signal transmission for the antenna beams. Signal processing techniques may include combining antenna elements 132 of the access point 110 in such a way that signals at particular angles experience constructive interference thus being amplified while other signals experience destructive interference thus being attenuated and can be used during both the transmission and reception of radio signals in order to achieve spatial selectivity. Antenna beams directed by the access point 110 may be steerable. For example, in some embodiments, the access point 110 may direct antenna beams that are continuously steerable independent of each other.

Block 253 of method 250 in FIG. 3 includes transmitting, by the wireless apparatus, a first signal in the first direction. Block 254 includes transmitting, by the wireless apparatus, a second signal in the second direction. For example, the access point 110 in FIG. 4 may transmit a first signal in the first antenna beam direction 404, and a second signal in the fifth antenna beam direction 412, as indicated by the shading in FIG. 4. Because the first antenna beam direction 404 and the fifth antenna beam direction 412 are separated in space, or are otherwise spaced apart, risk of interference between the two beams may be reduced. In some embodiments, the first signal and the second signal may be transmitted at substantially the same time or at the same time. The first and second signals may be predefined signals. In some embodiments, the first and second signals may have identical waveforms. In other embodiments, the first and second signals may have substantially different waveforms. For example, a first waveform may be based at least in part on a first identifier corresponding to the first antenna beam direction, and a second waveform may be based at least in part on a second identifier corresponding to the second antenna beam direction.

At block 255 of FIG. 3, the method 250 includes receiving, by the wireless apparatus, a first response to the first signal from a first user device. Block 256 includes receiving, by the wireless apparatus, a second response to the second signal from a second user device. In some embodiments, the first response and the second response may have identical waveforms. In other embodiments, the first response and the second response may have substantially different waveforms. For example, the first response may be based at least in part on a first identifier corresponding to the first antenna beam direction, and the second response may be based at least in part on a second identifier corresponding to the second antenna beam direction. For example, in FIG. 4, a first user device positioned along the first antenna beam direction 404 may receive the first signal and may send a response to the access point 110, and a second user device positioned along the fifth antenna beam direction 412 may receive the second signal and may send a response to the access point 110. In some embodiments, the access point 110 may establish a first directional communication link with the first user device, and may establish a second directional communication link with the second user device. Establishing the directional communication link may include transmitting data to the user device or receiving data from the user device

At block 257, the method 250 includes determining, by the wireless apparatus, a first beam setting for the first user device based at least in part on the first response, and block 258 includes determining, by the wireless apparatus, a second beam setting for the second user device based at least in part on the second response. For example, in FIG. 4, the access point 110 may determine a first beam setting for the first user device that responded to the first signal, and a second beam setting for the second user device that responded to the second signal. For example, if user device 200 provides indication of preference of beam direction 404 used by access point 110, the access point 110 may select beam settings corresponding to the direction 404 to arrange directional link with user device 200.

Referring now to FIG. 5, after transmitting signals in the first beam direction 404 and the fifth antenna beam direction 412, the access point 110 may subsequently transmit signals in a different direction of the first set of antenna beam directions 401 and a different direction of the second set of antenna beam directions 402. For example, the access point 110 may transmit signals in the third antenna beam direction 408 and the sixth antenna beam direction 414, as shown by the shaded portions in FIG. 5. After transmitting signals in the third antenna beam direction 408 and the sixth antenna beam direction 414, in FIG. 6 the access point 110 may transmit signals in the remaining antenna beams, the second antenna beam direction 406 and the fourth antenna beam direction 410. Any of the antenna beam directions may be searched, via transmission of signals, at substantially the same time. For example, every second antenna beam may be searched, via transmission of signals, at substantially the same time, every third antenna beam may be searched at substantially the same time, every fourth antenna beam may be searched at substantially the same time, or any other arrangement. In some embodiments, random pairs of antenna beams may be searched at substantially the same time. Although in FIGS. 4-6 the searching operation is shown in a specific format, any one of the embodiments illustrated in FIGS. 4-6 may be the first step in a searching operation. For example, the embodiment of FIG. 5 may be the first searching operation, FIG. 6 may be the second searching operation, and FIG. 4 may be the third searching operation. Any other order may be used in implementing the searching operations discussed herein.

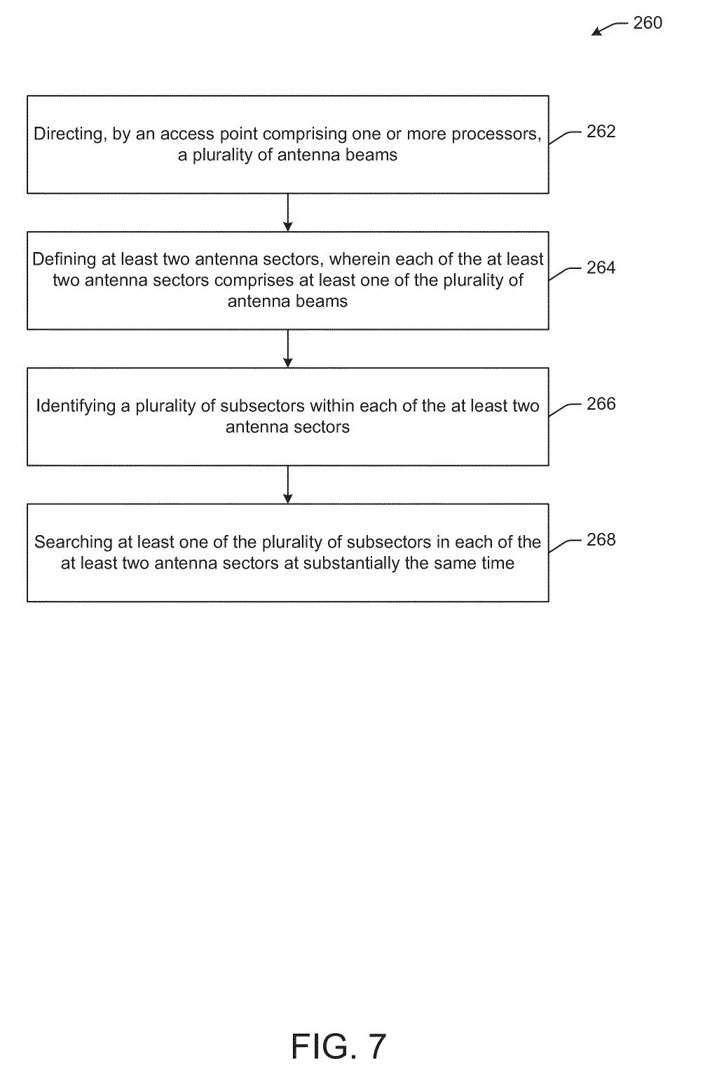

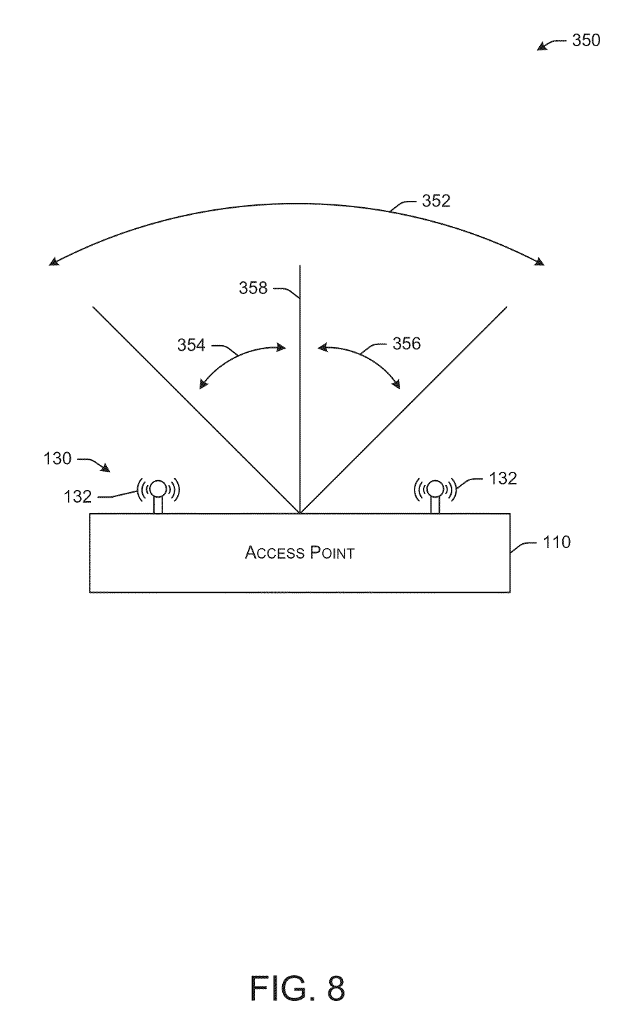

Referring now to FIGS. 7 and 8, an example method 260 of optimizing wireless communication and an example directional transmission 350 from the access point 110 of FIG. 2 according to one embodiment of the disclosure are illustrated and will be discussed in conjunction with each other. Referring first to FIG. 7, block 262 of method 260 includes directing, by the access point 110, a plurality of antenna beams. In FIG. 8, directional transmission 350 from the access point 110 is illustrated in a top view. The access point 110 directs a plurality of antenna beams in the direction of a coverage area 352 of the access point 110. The access point 110 may direct the antenna beams using the directional antenna array 130 and specific antenna elements 132. The coverage area 352 may be determined, for example, by the beamforming module 126 of the access point 110. The coverage area 352 may be adjusted by adjusting power and/or phases provided to the antenna elements 132 of the directional antenna array 130 of the access point 110. For example, increasing power to certain antenna elements 132 of the directional antenna array 130 of the access point 110 may result in increased gain and signal strength transmitted from the antenna element 132. The antenna beams may be millimeter wave wireless transmissions sent by the access point 110 in some embodiments.

At block 264 of method 260 in FIG. 7, the access point 110 may define at least two antenna sectors, wherein each of the at least two antenna sectors includes at least one of the plurality of antenna beams. For example, referring to FIG. 8, the access point 110 may define a first antenna sector 354 and a second antenna sector 356. The first and second antenna sectors 354, 356 may be of substantially the same size and may be defined within the coverage area 352 provided by the access point 110. The first and second antenna sectors 354, 356 may each include an equal number of antenna beams, or in instances where a total number of antenna beams directed by the access point 110 is odd, the first and second antenna sectors 354, 356 may include different numbers of antenna beams. In some embodiments, additional or fewer antenna sectors may be defined, for example, 100 or more antenna sectors.

The illustrated example in FIG. 8 illustrates the first antenna sector 354 and the second antenna sector 356 that may be configured for sectorized transmissions from the access point 110. As an example of sectorized transmissions, a user device that is positioned within the first antenna sector 354 may be able to receive a relatively strong signal from the access point 110 while the access point 110 is transmitting in the first antenna sector 354, but may receive a relatively weak, or even undetectable, signal from the access point 110 while the access point 110 is transmitting in any other antenna sector. If a user device is located near a border between two adjacent antenna sectors, for example border 358 between the first antenna sector 354 and the second antenna sector 356 of the access point 110, the user device may receive a usable signal from either or both of the first and second antenna sectors 354, 356, although one signal may be stronger than the other.

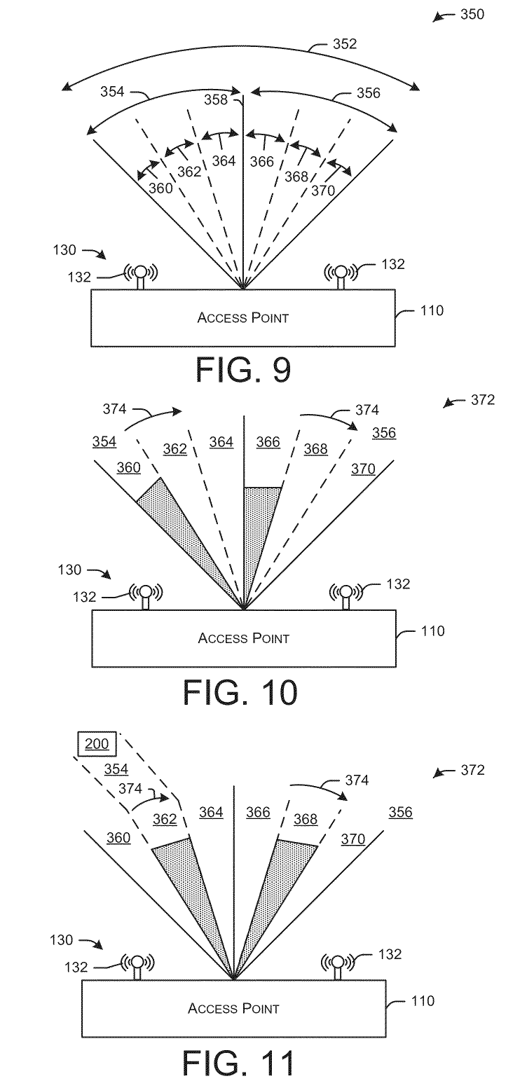

Block 266 of method 260 in FIG. 7 includes identifying, by the access point 110, a plurality of subsectors within each of the at least two antenna sectors. Referring now to FIG. 9, the access point 110 in the illustrated embodiment, may identify a plurality of subsectors within each of the at least two antenna sectors. For example, the access point 110 may identify a first subsector 360, a second subsector 362, and a third subsector 364 within the first antenna sector 354. The access point 110 may similarly identify a first subsector 366, a second subsector 368, and a third subsector 370 within the second antenna sector 356. Each subsector identified by the access point 110 may fall within a specific antenna sector. In instances where overlap occurs, for example overlap between antenna sectors or overlap between subsectors, or both, the risk of error may increase. Each subsector identified by the access point 110 may be substantially the same size in some embodiments. Additional subsectors may be identified by the access point 110 in other embodiments. The maximum number of subsectors or antenna sectors defined or identified may correspond to a minimum beam width the directional antenna array 130 of the access point 110 is configured to create or direct.

In embodiments where the access point 110, or both the access point and the user device, is directing antenna beams with high gain and narrow width for example in instances with a high number of subsectors, targeting or mutual targeting of the user device and the access point 110 may be difficult. Therefore, frequent beam setting updates may improve link quality between the access point and user devices. Also, because some user devices may sometimes be moved during operation, thus changing the optimal selection of sectors for transmission data, as discussed above, the access point 110 or user devices may perform searching operations. During searching operations, sector sweeps may be performed by the access point 110 or user device. In some instances, searching operations may be triggered by low signal quality, interrupted communication, or other user defined event. In some embodiments, the wireless communication system 100 may be configured to have a beam sector update frequency for each individual connected user device, which may trigger searching operations.

In FIG. 7, block 268 of method 260 includes searching, by the access point, at least one of the plurality of subsectors in each of the at least two antenna sectors at substantially the same time. It should be noted, that the method 260 may be modified in various ways in accordance with certain embodiments of the disclosure. For example, one or more operations of method 260 may be eliminated or executed out of order in other embodiments of the disclosure. Additionally, other operations may be added to method 260 in accordance with other embodiments of the disclosure. Referring now to FIGS. 10 and 11, a searching operation 372 performed by the access point 110 is illustrated. The access point 110 may search at least one of the plurality of subsectors 360-370 in each of the first and second antenna sectors 354, 356 at substantially the same time. Searching may be determined by the searching module 124 and may include any searching operation performed by the access point 110. In one embodiment, a searching operation may include directionally transmitting, by the access point 110, a first probe beacon within the first subsector 360 of the first antenna sector 354, where the first beacon includes a first identifier of the first subsector 360 of the first antenna sector 354. The access point 110 may also directionally transmit a second probe beacon within a first subsector 366 of the second antenna sector 356, where the second beacon includes a second identifier of the first subsector 366 of the second antenna sector 356. The first and second beacons may include a sounding preamble and/or a data portion to arrange measurements. In the embodiment of FIG. 10, the subsectors being searched by the access point 110 are shaded in for illustration. In some embodiments, all subsectors of all antenna sectors may be searched by the access point 110 at the same time or at substantially the same time. Such embodiments may include flexible or highly sensitive elements as part of the directional antenna array that are configured to direct narrow antenna beams in order to reduce error.

The probe beacon sent by the access point 110 during a searching operation may include a sounding preamble. A sounding preamble may allow the receiving user devices to discover the access point 110, and may also allow the access point 110 to detect the presence of user devices in all of the antenna sectors and/or subsectors of the access point 110. The sounding preamble may include a sounding signal that may be predefined and known to the receiving user device. In some embodiments, the sounding preamble may not include user device specific service information attached to the preamble. In some embodiments, probe beacons transmitted in specific subsectors by the access point 110 during searching operations may include information such as the identity of the particular subsector and antenna sector that is being searched at that time. A user device may receive the probe beacon and may respond using a sector sweep approach such as that described above with respect to the access point or any other suitable approach.

In the illustrated example of FIGS. 10 and 11, probe beacons may be transmitted by the access point 110 during searching operations. Probe beacons may be addressed to those devices that are already associated or connected with the access point, or may be used to detect new or unconnected devices. Probe beacons addressed to the connected devices may be directionally transmitted, while beacons for user device detection may be transmitted in each antenna sector and/or sub sector.

During searching operations, the access point 110 may use a subsector sweep technique. A subsector sweep transmission is a technique in which data, for example a probe beacon, is transmitted in each individual subsector at separate times, until that data has been transmitted in all of the subsectors. For example, the directional arrows 374 in FIGS. 10 and 11 illustrate a clockwise subsector sweep. The subsectors may typically be selected in sequential order, either clockwise or counterclockwise, but other orders of selection may also be used, as discussed herein. The data transmitted in each subsector may contain the identification of the subsector currently being used in some embodiments, so that the receiving devices will know which of the access point's 110 subsectors provide the user device with the best signal. Timing information, if included, may also be different for each subsector, since each beacon or data may be transmitted at a different time.

User devices may receive probe beacons from the access point, and may generate a response to the probe signal. The response may indicate a preferred subsector and/or sector for the user device, to optimize wireless communication between the access point 110 and the user device. Responses from the user devices to probe beacons from the access point 110 may contain several pieces of information, such as but not limited to: 1) a request to become associated with the access point; 2) the identity or an identifier of the responding user device; 3) the antenna sector and/or subsector identifier of the device that this particular response is being transmitted to; and 4) the sector and/or subsector identifier that was contained in the beacon that the user device is responding to. In instances where a user device is able to receive the probe beacon in more than one subsector, the user device may specify which of those subsectors or antenna sectors it prefers (typically the sector that contained the best quality signal, as determined by signal strength and/or signal-to-noise ratio, though other criteria may be used).

For example, in FIG. 11, the first user device 200 may receive a probe beacon from the access point 110 while the access point 110 is searching the second sub sector 362 of the first antenna sector 354. Using the request/response module 218, the first user device 200 may determine that the second subsector 362 of the first antenna sector 354 provides an optimal signal or connection to the access point 110. The first user device 200 may generate a response including information identifying the second subsector 362 of the first antenna sector 354 and, using communication module 216, may transmit the response to the access point 110. The access point 110 may receive the response and may analyze the response using beamforming module 126. The access point 110 may include one radio frequency signal processing chain for each antenna beam directed by the access point 110. The radio frequency signal processing chain may be used by the access point 110 to simultaneously interpret responses received from multiple user devices. In other embodiments, the access point 110 may include a different number of radio frequency processing chains. The access point 110 may include at least two substantially independent radio frequency processing chains.

The access point 110 may, using the beamforming module 126, increase power to or otherwise adjust the signal provided to the first user device 200 by the directional antenna array 130 of the access point 110 based at least in part on the response received from the first user device 200. Adjusting the signal or antenna beam, for example adjusting gain, power, or directionality, may optimize or improve the connection quality between the access point 110 and the user device 200. For example, the access point 110 may determine a positioning of the user device 200 within a specific subsector based at least in part on a response received from the user device.

Referring still to FIG. 11, the access point 110 may continue to sweep the subsectors of both the first and second sectors by searching the second subsector of both the first and second sectors at substantially the same time. In some embodiments sweeping may occur in a counter-clockwise direction or in a random order, where random corresponding subsectors are searched at substantially the same time or at the same time, or where random subsectors in each antenna sector are searched at substantially the same time or at the same time. However, physical spacing between subsectors being searched may reduce errors due to interfering signals or antenna beams. The searching operations described herein may be used for both the uplink and downlink communication between the user devices and access point. For example, in the uplink, the user device may transmit a probe signal to the access point, and in the downlink, the access point may transmit the probe signal to the user device.

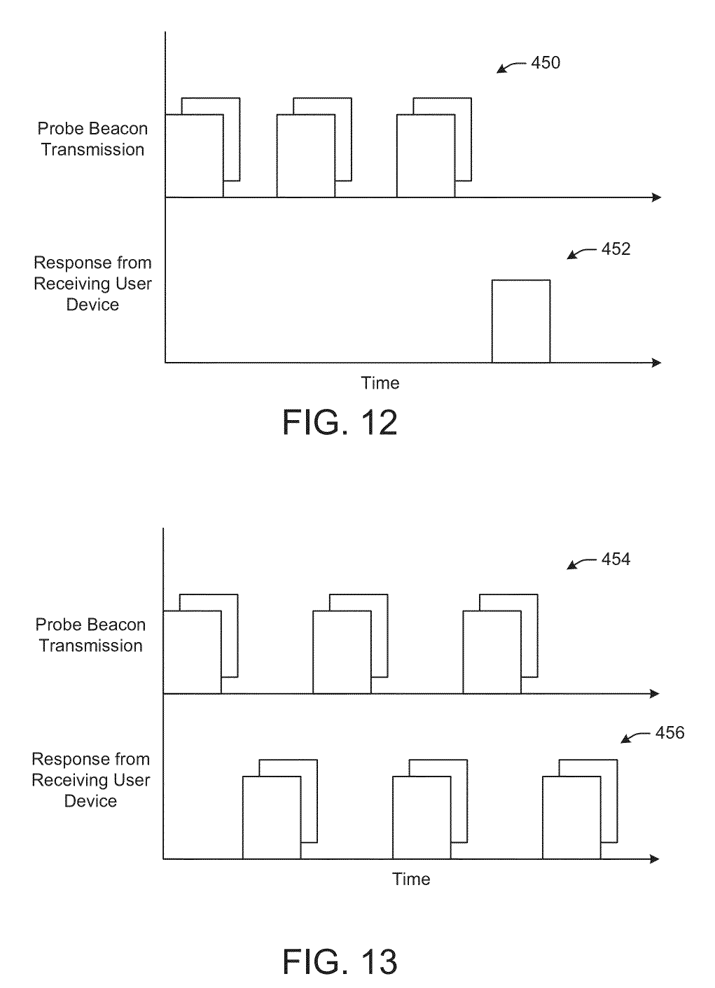

Referring now to FIGS. 12 and 13, various ways to send beacons and receive the responses are shown. In some embodiments, depicted in FIG. 12, probe beacons transmitted by the access point 110 may include antenna beam, antenna sector, or antenna subsector identifiers. In these embodiments, the responses transmitted by user devices, such as device 200 of FIG. 2, may also contain antenna beam, antenna sector or antenna subsector identifiers. In other embodiments, depicted in FIG. 13, probe beacons transmitted by the access point 110 may not include antenna beam, antenna sector, or antenna subsector identifiers. Instead, the access point 110 may identify responses from user devices based at least in part on the time at which the access point 110 receives the response. For instance, the proximity in which a response is received to the time at which a probe beacon is transmitted may correlate a response with the immediately previously searched subsector.

For example, in FIG. 12, probe beacons may be sent 450 in two different antenna beam directions, or in two subsectors of two different antenna sectors, and upon completing the sending of probe beacons in all three subsectors, the receiving user device sends a response. The response 452 may indicate a preferred antenna beam direction or antenna sector for the user device, as well as other beam setting information, as discussed above. By sending two probe beacons at a time, a total length of searching time may be reduced by half. Similarly, searching three different antenna beam directions or subsectors of three different antenna sectors at a time may reduce searching time by two-thirds.

In FIG. 13, another technique may be implemented by the access point 110. The access point 110 may transmit probe signals 454 as described herein, but user devices receiving the probe signals may respond with response signals 456 just after receiving the probe signal from the access point 110, rather than waiting until searching of all antenna beam directions or subsectors is complete. Multiple responses from different user devices may be received by the access point 110 simultaneously or at substantially the same time via receive beams. The receive beams may be steered in the same direction as the transmit beams immediately preceding the receive beams. After sending probe beacons, the access point 110 may wait for responses from user devices that may reside in that specific beam direction or subsector. Waiting time in FIG. 13 may be determined, for example by maximum roundtrip delay, response signal duration, processing delay at the user device, or other related factors.

The systems and methods described herein may reduce the length of time spent by wireless communication networks, for example millimeter wave wireless networks, steering or training antenna beams of user devices and access points by searching multiple subsectors in parallel or substantially in parallel. The systems and methods described herein may allow directional antenna arrays of millimeter wave communication networks to function and/or operate in different environments, for example outdoors, and may optimize wireless communication by quickly identifying optimal communication settings.

Embodiments described herein may be implemented using hardware, software, and/or firmware, for example, to perform the methods and/or operations described herein. Certain embodiments described herein may be provided as one or more tangible machine-readable media storing machine-executable instructions that, if executed by a machine, cause the machine to perform the methods and/or operations described herein. The tangible machine-readable media may include, but is not limited to, any type of disk including floppy disks, optical disks, compact disk read-only memories (CD-ROMs), compact disk rewritable (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of tangible media suitable for storing electronic instructions. The machine may include any suitable processing or computing platform, device or system and may be implemented using any suitable combination of hardware and/or software. The instructions may include any suitable type of code and may be implemented using any suitable programming language. In other embodiments, machine-executable instructions for performing the methods and/or operations described herein may be embodied in firmware. Additionally, in certain embodiments, a special-purpose computer or a particular machine may be formed in order to identify actuated input elements and process the identifications.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

While certain embodiments of the invention have been described in connection with what is presently considered to be the most practical and various embodiments, it is to be understood that the invention is not to be limited to the disclosed embodiments, but on the contrary, is intended to cover various modifications and equivalent arrangements included within the scope of the claims. Although specific terms are employed herein, they are used in a generic and descriptive sense only, and not for purposes of limitation.

This written description uses examples to disclose certain embodiments of the invention, including the best mode, and also to enable any person skilled in the art to practice certain embodiments of the invention, including making and using any devices or systems and performing any incorporated methods. The patentable scope of certain embodiments of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

According to example embodiments of the disclosure, there may be a method. The method may include selecting, by a wireless apparatus comprising one or more processors, a first direction at which to direct a first directional antenna beam, the first direction selected from a first set of antenna beam directions comprising a first plurality of antenna beam directions. The method may include selecting, by the wireless apparatus, a second direction at which to direct a second directional antenna beam, the second direction selected from a second set of antenna beam directions comprising a second plurality of antenna beam directions. The method may also include transmitting, by the wireless apparatus, a first signal in the first direction, and transmitting, by the wireless apparatus, a second signal in the second direction. The method may include receiving, by the wireless apparatus, a first response to the first signal from a first user device, and receiving, by the wireless apparatus, a second response to the second signal from a second user device. The method may include determining, by the wireless apparatus, a first beam setting for the first user device based at least in part on the first response, and determining, by the wireless apparatus, a second beam setting for the second user device based at least in part on the second response.

In example embodiments of the disclosure, there may be one or more computer-readable media comprising computer-executable instructions that, when executed by one or more processors, configure the one or more processors to perform a method. The method may include directing, by an access point comprising one or more processors, a plurality of directional antenna beams, and defining, by the access point, at least two directional antenna sectors, wherein each of the at least two directional antenna sectors comprises at least one of the plurality of directional antenna beams. The method may include identifying, by the access point, a plurality of subsectors within each of the at least two directional antenna sectors, and searching, by the access point, at least one of the plurality of subsectors in each of the at least two directional antenna sectors at substantially the same time. In some embodiments, the method may include directionally transmitting, by the access point, a first beacon within a subsector of a first directional antenna sector, the first beacon comprising a first identifier of the subsector of the first directional antenna sector, and directionally transmitting, by the access point, a second beacon within a subsector of a second directional antenna sector, the second beacon comprising a second identifier of the subsector of the second directional antenna sector. Searching may include millimeter wave wireless transmissions sent by the access point. The access point comprises a directional antenna array configured to direct the directional antenna beams. A total number of the plurality of subsectors identified by the access point in each of the at least two directional antenna sectors corresponds to a maximum number of directional antenna beams the access point is configured to direct. Each of the plurality of subsectors identified by the access point is searched at substantially the same time. Each of the at least two directional antenna sectors is substantially the same size.

In example embodiments of the disclosure, there may be an access point. The access point may include at least one memory that stores computer-executable instructions and at least one processor configured to access the at least one memory. The at least one processor may be configured to execute the computer-executable instructions to direct a plurality of directional antenna beams, and define at least two directional antenna sectors, wherein each of the at least two directional antenna sectors comprises at least one of the plurality of directional antenna beams, and identify a plurality of subsectors within each of the at least two directional antenna sectors. The at least one processor may be configured to search at least one of the plurality of subsectors in each of the at least two directional antenna sectors at substantially the same time. During the search operation the at least one processor may be configured to directionally transmit a first beacon within a subsector of a first directional antenna sector, the first beacon comprising a first identifier of the subsector of the first directional antenna sector and directionally transmit a second beacon within a subsector of a second directional antenna sector, the second beacon comprising a second identifier of the subsector of the second directional antenna sector. The access point comprises a directional antenna array configured to direct the directional antenna beams. The access point is configured to transmit millimeter wave wireless transmissions. Each of the plurality of subsectors identified by the access point is searched at substantially the same time. A total number of the plurality of subsectors identified by the access point in each of the at least two directional antenna sectors corresponds to a maximum number of independent directional antenna beams the access point is configured to direct. Each of the at least two directional antenna sectors is substantially the same size.

The claimed invention is:

1. A method comprising:
selecting, by a wireless apparatus comprising one or more processors, a first direction at which to direct a first directional antenna beam, the first direction selected from a first set of antenna beam directions comprising a first plurality of antenna beam directions;
selecting, by the wireless apparatus, a second direction at which to direct a second directional antenna beam, the second direction selected from a second set of antenna beam directions comprising a second plurality of antenna beam directions;
transmitting, by the wireless apparatus, a first signal in the first direction;
transmitting, by the wireless apparatus, a second signal in the second direction;
receiving, by the wireless apparatus, a first response to the first signal from a first user device;
receiving, by the wireless apparatus, a second response to the second signal from a second user device;
determining, by the wireless apparatus, a first beam setting for the first user device based at least in part on the first response; and
determining, by the wireless apparatus, a second beam setting for the second user device based at least in part on the second response.

2. The method of claim 1, wherein transmission of the first signal and the second signal occurs at substantially the same time.

3. The method of claim 1, wherein the first direction and the second direction are selected such that the first signal is received by the first user device a predefined amount of decibels stronger than the second signal received by the first user device.

4. The method of claim 1, further comprising:
establishing, by the wireless apparatus, a first directional communication link with the first user device; and
establishing, by the wireless apparatus, a second directional communication link with the second user device;
wherein establishing the directional communication link comprises transmitting data to the user device or receiving data from the user device.

5. The method of claim 1, wherein transmitting the signal by the wireless apparatus comprises transmitting a predefined signal.

6. The method of claim 1, wherein the first signal and the second signal each have identical waveforms.

7. The method of claim 6, wherein the first response and the second response received by the wireless apparatus have identical waveforms.

8. The method of claim 1, wherein the first signal received by the wireless apparatus has a first waveform, and the second signal received by the wireless apparatus has a second waveform that is substantially different than the first waveform.

9. The method of claim 8, wherein the first waveform is based at least in part on a first identifier corresponding to the first direction, and the second waveform is based at least in part on a second identifier corresponding to the second direction.

10. The method of claim 9, wherein the first response received by the wireless apparatus is based at least in part on the first identifier, and the second response received by the wireless apparatus is based at least in part on the second identifier.

11. The method of claim 1, wherein the method further comprises:
selecting, by the wireless apparatus, a third direction from the first plurality of antenna beam directions at which to direct a third directional antenna beam;
selecting, by the wireless apparatus, a fourth direction from the second plurality of antenna beam directions at which to direct a fourth directional antenna beam;
transmitting, by the wireless apparatus, a third signal in the third direction;
transmitting, by the wireless apparatus, a fourth signal in the fourth direction;
receiving, by the wireless apparatus, a third response to the third signal from a third user device;
receiving, by the wireless apparatus, a fourth response to the fourth signal from a fourth user device;
determining, by the wireless apparatus, a third beam setting for the third user device based at least in part on the third response; and
determining, by the wireless apparatus, a fourth beam setting for the fourth user device based at least in part on the fourth response.

12. One or more computer-readable media comprising computer-executable instructions that, when executed by one or more processors, configure the one or more processors to perform a method comprising:
selecting, by a wireless apparatus comprising one or more processors, a first direction at which to direct a first directional antenna beam, the first direction selected from a first set of antenna beam directions comprising a first plurality of antenna beam directions;
selecting, by the wireless apparatus, a second direction at which to direct a second directional antenna beam, the second direction selected from a second set of antenna beam directions comprising a second plurality of antenna beam directions;
transmitting, by the wireless apparatus, a first signal in the first direction;
transmitting, by the wireless apparatus, a second signal in the second direction;
receiving, by the wireless apparatus, a first response to the first signal from a first user device;
receiving, by the wireless apparatus, a second response to the second signal from a second user device;
determining, by the wireless apparatus, a first beam setting for the first user device based at least in part on the first response; and
determining, by the wireless apparatus, a second beam setting for the second user device based at least in part on the second response.

13. The one or more computer-readable media of claim 12, wherein transmission of the first signal and the second signal occurs at substantially the same time.

14. The one or more computer-readable media of claim 12, wherein the method further comprises:
establishing, by the wireless apparatus, a first directional communication link with the first user device; and
establishing, by the wireless apparatus, a second directional communication link with the second user device;
wherein establishing the directional communication link comprises transmitting data to the user device or receiving data from the user device.

15. The one or more computer-readable media of claim 12, wherein transmitting the signal by the wireless apparatus comprises transmitting a predefined signal.

16. The one or more computer-readable media of claim 12, wherein the first signal and the second signal each have identical waveforms.

17. The one or more computer-readable media of claim 16, wherein the first response and the second response received by the wireless apparatus have identical waveforms.

18. The one or more computer-readable media of claim 12, wherein the first signal received by the wireless apparatus has a first waveform, and the second signal received by the wireless apparatus has a second waveform that is substantially different than the first waveform.

19. The one or more computer-readable media of claim 18, wherein the first waveform is based at least in part on a first identifier corresponding to the first direction, and the second waveform is based at least in part on a second identifier corresponding to the second direction.

20. The one or more computer-readable media of claim 19, wherein the first response received by the wireless apparatus is based at least in part on the first identifier, and the second response received by the wireless apparatus is based at least in part on the second identifier.

21. The one or more computer-readable media of claim 12, wherein the method further comprises:
selecting, by the wireless apparatus, a third direction from the first plurality of antenna beam directions at which to direct a third directional antenna beam;
selecting, by the wireless apparatus, a fourth direction from the second plurality of antenna beam directions at which to direct a fourth directional antenna beam;
transmitting, by the wireless apparatus, a third signal in the third direction;
transmitting, by the wireless apparatus, a fourth signal in the fourth direction;
receiving, by the wireless apparatus, a third response to the third signal from a third user device;
receiving, by the wireless apparatus, a fourth response to the fourth signal from a fourth user device;
determining, by the wireless apparatus, a third beam setting for the third user device based at least in part on the third response; and
determining, by the wireless apparatus, a fourth beam setting for the fourth user device based at least in part on the fourth response.

22. A user device comprising:
a first antenna element configured to direct directional antenna beams;
a second antenna element configured to direct directional antenna beams;
at least one memory that stores computer-executable instructions; and
at least one processor configured to access the at least one memory, wherein the at least one processor is configured to execute the computer-executable instructions to:
select a first direction at which to direct a first directional antenna beam, the first direction selected from a first set of antenna beam directions comprising a first plurality of antenna beam directions;
select a second direction at which to direct a second directional antenna beam, the second direction selected from a second set of antenna beam directions comprising a second plurality of antenna beam directions;
transmit a first signal in the first direction;
transmit a second signal in the second direction;
receive a first response to the first signal from a first user device;
receive a second response to the second signal from a second user device;
determine a first beam setting for the first user device based at least in part on the first response; and
determine a second beam setting for the second user device based at least in part on the second response.

23. The user device of claim 22, wherein the at least one processor is further configured to execute the computer-executable instructions to:
establish a first directional communication link with the first user device; and
establish a second directional communication link with the second user device;
wherein establishing the directional communication link comprises transmitting data to the user device or receiving data from the user device.
